(19) United States
(12) Patent Application Publication
(10) Pub. No.: US 2021/0373584 A1
(43) Pub. Date: Dec. 2, 2021

(54) COMPUTER-CONTROLLED VALVE ARRAY

(71) Applicants: William C. Patton, JR., Campbellsville, KY (US); Jose E. Cardona Rivera, Chicago, IL (US)

(72) Inventors: William C. Patton, JR., Campbellsville, KY (US); Jose E. Cardona Rivera, Chicago, IL (US)

(21) Appl. No.: 17/313,058

(22) Filed: May 6, 2021

Related U.S. Application Data
(60) Provisional application No. 63/030,717, filed on May 27, 2020.

(51) Int. Cl. G05D 7/06; G01F 15/00; G01F 15/06; G01F 11/32

(52) U.S. Cl. CPC G05D 7/0635; G01F 11/32; G01F 15/068; G01F 15/005

(57) ABSTRACT

In accordance with the principals of the present invention, a computer-controlled valve array to meter fluids is provided. An intake manifold defines a fluid-inlet chamber. A fluid inlet is in fluid communication with the fluid-inlet chamber of the intake manifold, the fluid inlet adapted to receive a high-pressure source of fluid. A number of valves have an inlet and an outlet. In an embodiment, the valves comprise pintle valves. At least one valve inlet is in fluid communication with the fluid-inlet chamber. The valves are electronically controlled to allow fluid through in response to a trigger. An outtake manifold is in fluid communication with the valve outlets. Outlet ports are in fluid communication with the outtake chamber of the outlet manifold. The outlet ports are adapted to receive and fluid communicate with the output circuit.

### CROSS-REFERENCE TO RELATED APPLICATIONS

This utility patent application claims the benefit of and priority to U.S. Provisional Patent Application No. 63/030,717, filed 27 May 2020, also entitled “Computer-Controlled Valve Array”, the content of which is hereby incorporated by this reference.

### FIELD OF THE INVENTION

The present invention relates to a computer-controlled valve array.

### BACKGROUND OF THE INVENTION AND STATE OF THE ART

A valve is a device that regulates, directs or controls the flow of a fluid (gases, liquids, fluidized solids, or slurries) by opening, closing or partially obstructing various passageways. Valves are technically fittings, but are usually seen as a separate category. In an open valve, fluid flows in a direction from higher pressure to lower pressure. Valves are found in virtually every industrial process, including water and sewage processing, mining, power generation, processing of oil, gas and petroleum, food manufacturing, chemical and plastic manufacturing and many other fields.

### SUMMARY OF THE INVENTION

This Summary of the Invention is provided to introduce a selection of concepts in a simplified form that are further described below in the Detailed Description section. This Summary of the Invention is not intended to identify key features or essential features of the claimed subject matter, nor is it intended to be used as an aid in determining the scope or spirit of the claimed subject matter.

In accordance with the principals of the present invention, a computer-controlled valve array to meter fluids is provided. An intake manifold defines a fluid-inlet chamber. A fluid inlet is in fluid communication with the fluid-inlet chamber of the intake manifold, the fluid inlet adapted to receive a high-pressure source of fluid. A number of valves have an inlet and an outlet. In an embodiment, the valves comprise pintle valves. At least one valve inlet is in fluid communication with the fluid-inlet chamber. The valves are electronically controlled to allow fluid through in response to a trigger. An outtake manifold is in fluid communication with the valve outlets. Outlet ports are in fluid communication with the outtake chamber of the outlet manifold. The outlet ports are adapted to receive and fluid communicate with the output circuit.

This Summary of the Invention introduces concepts in a simplified form that are further described below in the Detailed Description. This Summary of the Invention is not intended to identify key features or essential features of the claimed subject matter, nor is it intended to be used as an aid in determining the scope of the claimed subject matter.

### BRIEF DESCRIPTION OF THE DRAWINGS

The accompanying Drawings illustrate several embodiments and, together with the description, serve to explain the principles of the present invention according to the example embodiments. It will be appreciated by one skilled in the art that the particular arrangements illustrated in and described with respect to the Drawings are merely exemplary and are not to be considered as limiting of the scope or spirit of the present invention in any way.

FIG. 1 is a perspective view of a computer-controlled valve array assembly according to an example embodiment in accordance with the principals of the present invention.

FIG. 2 is a cut-away, elevated view of an example automotive pintle valve for use in the example computer-controlled valve array of FIG. 1.

FIG. 3 is an exploded view of the example computer-controlled valve array of FIG. 3.

FIG. 4A is a front, sectional view of the example computer-controlled valve array of FIG. 1 taken along the line indicated by “A” in FIG. 4B.

FIG. 4B is an elevated view of the example computer-controlled valve array of FIG. 1.

FIG. 5A a perspective view of a computer-controlled valve array assembly according to another example embodiment in accordance with the principals of the present invention.

FIG. 5B is a front, sectional view of the example computer-controlled valve array of FIG. 5A.

FIG. 5C is an exploded view of the example computer-controlled valve array of FIG. 5A.

FIG. 6 a perspective view of a computer-controlled valve array assembly according to another example embodiment in accordance with the principals of the present invention.

FIG. 7A, a fluid-flow chart of the example computer-controlled valve array of FIG. 1.

FIG. 7B, a fluid-flow mixing chart of the example computer-controlled valve array of FIG. 5A.

FIG. 8A is an example waveform graph and flow rate table showing an example of how the pintle valves can be turned on to create a desired waveform.

FIG. 8B is another example waveform graph and flow rate table showing another example of how the pintle valves can be turned on to create a desired waveform.

FIG. 9A is an example wave-shape graph showing an example of how the pintle valves can be turned on to create a desired wave shape.

FIG. 9B is a pintle-valve state lookup table corresponding to the example wave-shape graph of FIG. 9A.

FIG. 10A is another example wave-shape graph showing another example of how the pintle valves can be turned on to create a desired wave shape.

FIG. 10B is a pintle-valve state lookup table corresponding to the example wave-shape graph of FIG. 10A.

As noted above, in the above reference Drawings, the present invention is illustrated by way of example, not limitation, and modifications may be made to the elements illustrated therein, as would be apparent to a person of ordinary skill in the art, without departing from the scope or spirit of the invention.

### DETAILED DESCRIPTION OF EMBODIMENTS

### Introduction

A computer-controlled valve array (CCVA) in accordance with the principals of the present invention adapts fluid by controlling pressure, flow, volume, regulation, mixing, and waveshape using valves fixtured between two manifolds. A computer-controlled valve array (CCVA) in accordance with the principals of the present invention integrates piping, valves, and sensors into a small footprint. A computer-controlled valve array (CCVA) in accordance with the principals of the present invention can be used in pneumatic, hydraulic or mixing systems in a wide variety of applications.

By way of several examples, a computer-controlled valve array (CCVA) in accordance with the principals of the present invention can be applicable to a mechanical ventilator where air and oxygen (O₂) are regulated, mixed, and delivered to a patient circuit using precision control. A computer-controlled valve array (CCVA) in accordance with the principals of the present invention can be applicable to mixing precision amounts of petro-chemicals, such as for example paint mixing where a base fluid can be injected with additives along linear piping in a closed circuit. A computer-controlled valve array (CCVA) in accordance with the principals of the present invention can be applicable to beverage mixing where a base fluid mixes with carbonation or flavorings along linear piping in a closed circuit. A computer-controlled valve array (CCVA) in accordance with the principals of the present invention can be applicable to regulating the flow of fluids in industrial processes. A computer-controlled valve array (CCVA) in accordance with the principals of the present invention can be applicable to precisely regulate the flow of hydrogen in a fuel cell. A computer-controlled valve array (CCVA) in accordance with the principals of the present invention can be applicable to controlling the humidity of air in HVAC applications

A computer-controlled valve array in accordance with the principals of the present invention uses a plurality of computer-controlled valves to deliver a precise amount of pressure, flow, and volume of mixed fluid into and out of the target-device. The arrangement of the valve array is extensible by the number of valves and channels where each valve is independently addressable. Multiple valve arrays can be added in series, parallel or opposing configurations. In one aspect the computer-controlled valve array in accordance with the principals of the present invention is used to provide precise regulation of the flow, pressure, and volume of a single fluid; in another aspect the computer-controlled valve array in accordance with the principals of the present invention is used to provide precise regulation of the flow, pressure, volume, and concentration of multiple fluids in, one fluid out.

While not limited to such valves, in an embodiment of a computer-controlled valve array in accordance with the principals of the present invention a plurality of computer-controlled, automotive-pintle (injector) valves are utilized. Pintle valves are relatively inexpensive, reliable to millions of cycles, and readily available from the automotive industry. The pintle injector was invented for use in the aerospace industry by Gerard W. Alterum Jr. in the 1960s and was reduced to practice and developed by Space Technology Laboratories (STL), then a division of Ramo-Wooldridge Corp., and later TRW. The pintle injector is “off patent” having been subject to U.S. Pat. No. 3,205,656, issued 14 Sep. 1965, titled, “Variable Thrust Bipropellant Rocket Engine”, and U.S. Pat. No. 3,699,772, issued 24 Oct. 1972, titled, “Liquid Propellant Rocket Engine Coaxial Injector”. The pintle injector was designed as a propellant injector for bipropellant, liquid fueled rocket engines. The pintle injector was designed to ensure appropriate flow rate and intermixing as propellants are forcibly injected under high pressure into the combustion chamber, so that an efficient and controlled combustion process can happen. Pintle-based injectors have an improved throttling range over regular injectors. By creating a self-stabilizing flow pattern, pintle injectors rarely present acoustic combustion instabilities.

In accordance with the principals of the present invention, fluid flow is regulated and/or modulated by an array of computer-controlled pintle valves that are tightly fixtured between an intake manifold and an outtake manifold. One or more arrays of pintle valves may be provided, each dedicated to one or more fluid pathways. In an aspect in accordance with the principals of the present invention, it is practical, but not limited, to have one inlet chamber dedicated to one fluid and a second inlet chamber dedicated to another fluid. The pintle valves can accurately create a pressure-wave using computer-controlled, digital-modulation techniques. The arrangement, size, shape, porting, attachment, mounting, flow rates, voltage, and computer-controlled modulation can exist in many combinations and can be suitable for multiple applications.

In accordance with the principals of the present invention, a two-part manifold is provided (known herein as the computer-controlled-valve-array (CCVA)) that fixtures an array of pintle valves so that fluids travel in on one-side of the pintle valves through the intake manifold and thus leaves out of the pintle valves and into the outtake manifold. Each manifold consists of integrated pneumatic piping that guides the fluids through the circuit. Additionally, each manifold acts as a singular mounting fixture that adapts diverse fittings so that reliable connections can be maintained for ruggedized use.

In accordance with the principals of the present invention, the outtake manifold comprises a receiving chamber adapted to hold a fluid, mix different fluids, soften pneumatic or hydraulic spikes, and mount sensors. As such, the fluids mixed within this receiving chamber as part of the outtake manifold where pneumatic or hydraulic pressure spikes are softened by the effects of the volume of the receiving chamber and in the case of gases an optional companion output passive pressure snubber. The receiving chamber also is a convenient place to sense fluid concentration and pressure.

In a further aspect in accordance with the principals of the present invention, sensors are placed in the pneumatic or hydraulic circuit to ensure the desired function and mixing capabilities.

In a further aspect in accordance with the principals of the present invention, a computer-controlled valve array is provided that provides an array of electronically-modulated pintle valves that may have various flow rates and are modulated for various amounts of time in order to deliver the desired pressure and flow to the receiving chamber. The term wave shape is used herein to describe how the fluid pressure and flow over time would appear at the output port if plotted on a graph. A modulation scheme herein renders the fluid pressure/flow to create the wave shape. Alternatively, the desired wave shape can serve as the control signal input to drive the pintle valves. The wave shape is generated by various combinations of low-flow, medium-flow, and high-flow pintle valves that are opened in numerous combinatorial patterns or sequential pulses for varying amounts of time. The pintle valves also may be driven in response to sensor feedback.

In a further aspect in accordance with the principals of the present invention, a computer-controlled process consisting of one objective function and two error terms can be utilized to determine the desired fluid mixture. A computer-controlled valve array in accordance with the principals of the present invention can measure instantaneous pressure (or flow rate) as well as fluid concentration. Because of the simultaneous minimization of two error terms, a firing configuration lookup table can include the firing configuration(s) for different amounts of error in each term, thereby allowing for a stable system of elevated fluid concentration. An overriding objective function (and resultant pressure or flow rate output) exists, but with an arbitrarily chosen proportion of fluid. This is possible by virtue of the discrete nature of the firing configuration lookup table, where a constant number of pintle valves are output given different magnitudes of error in terms of pressure (or flow rate), but the proportion of pintle valves from each fluid is varied depending upon the magnitude of the concentration error term.

Pintle-valve actuation results in rapid pressure spikes as the high-pressure fluid on one side is suddenly allowed to flow through the pintle valve. A computer-controlled valve array in accordance with the principals of the present invention mitigates these spikes by optionally incorporating the receiving chamber with an outlet connected to a passive pressure snubber. The pintle-valve outlets combine in this receiving chamber and then flow through the passive pressure snubber to the next chamber. This receiving chamber provides fluid mixing and reduces the pressure spikes from the pintle actuation passively. No power is required for, nor does the passive pressure snubber prevent the fluid from flowing to the next chamber, reducing the overall number of pintle valves and controls while maintaining steady flow. A flexible chamber attached to the outlet chamber may also serve to reduce pressure spikes as it can deform in response to pressure changes, reducing the magnitude of any pressure spikes.

### Initial Considerations

Generally, one or more different embodiments may be described in the present application. Further, for one or more of the embodiments described herein, numerous alternative arrangements may be described; it should be appreciated that these are presented for illustrative purposes only and are not limiting of the embodiments contained herein in any way. One or more of the arrangements may be widely applicable to numerous embodiments, as may be readily apparent from the disclosure.

In general, arrangements are described in sufficient detail to enable those skilled in the art to practice one or more of the embodiments, and it should be appreciated that other arrangements may be utilized and that structural, logical, software, electrical and other changes may be made without departing from the scope or spirit of the present invention. Particular features of one or more of the embodiments described herein may be described with reference to one or more particular embodiments or figures that form a part of the present invention, and in which are shown, by way of illustration, specific arrangements of one or more of the aspects. It should be appreciated, however, that such features are not limited to usage in the one or more particular embodiments or figures with reference to which they are described. The present disclosure is neither a literal description of all arrangements of one or more of the embodiments nor a listing of features of one or more of the embodiments that must be present in all arrangements.

Headings of sections provided in this patent application and the title of this patent application are for convenience only and are not to be taken as limiting the present invention in any way.

Devices and parts that are connected to or in fluid communication with each other need not be in continuous connection or fluid communication with each other, unless expressly specified otherwise. In addition, devices and parts that are connected to or in fluid communication with each other may fluid communicate directly or indirectly through one or more connection or fluid communication means or intermediaries, logical or physical.

A description of an aspect with several components in connection or fluid communication with each other does not imply that all such components are required. To the contrary, a variety of optional components may be described to illustrate a wide variety of possible embodiments and in order to more fully illustrate one or more embodiments.

When a single device or article is described herein, it will be readily apparent that more than one device or article may be used in place of a single device or article. Similarly, where more than one device or article is described herein, it will be readily apparent that a single device or article may be used in place of the more than one device or article.

The functionality or the features of a device may be alternatively embodied by one or more other devices that are not explicitly described as having such functionality or features. Thus, other embodiments need not include the device itself.

Techniques and mechanisms described or referenced herein will sometimes be described in singular form for clarity; however, it should be appreciated that particular embodiments may include multiple iterations of a technique or multiple instantiations of a mechanism unless noted otherwise. Alternate implementations are included within the scope or spirit of various embodiments in which, for example, functions may be executed out of order from that shown or discussed, including substantially concurrently or in reverse order, depending on the functionality involved, as would be understood by those having ordinary skill in the art.

### Conceptual Architecture

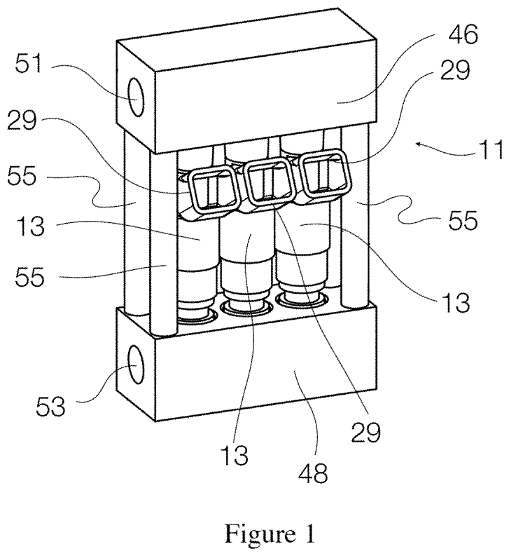

In more detail and referring to FIG. 1, a perspective view of a computer-controlled valve array 11 according to an example embodiment in accordance with the principals of the present invention is seen. The FIG. 1 example shows a basic three valve, three flow, one array computer-controlled valve array 11.

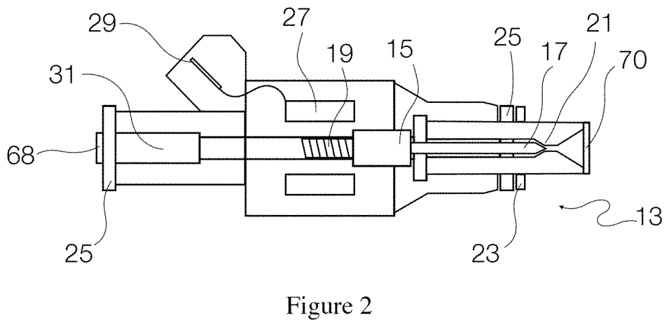

Referring to FIG. 2, a cut-away, elevated view of an automotive pintle valve 13 for use in the example computer-controlled valve array 11 of FIG. 1 is seen. Automotive pintle valves 13 control the flow of fuel by using a small electronic solenoid 15 which can be cycled on and off about 200 times per second. A small needle 17 is spring loaded 19 to normally maintain the pintle valve 13 shut. When the solenoid 15 is powered, the needle 17 is pulled back, allowing flow through the pintle valve 13. The pintle needle 17 is contained on a valve seat 21: the valve seat 21 is precision machined to match the pintle needle 17. The pintle needle 17 is contained on the valve seat 21 by a cap 23 securing an O-ring 25. The pintle needle 17 comprises a finely-machined part that normally sits down on the valve seat 21 to prevent the mixture from passing through; when opened, the pintle needle 17 allows the mixture through. A coil winding 27 is provided. When the coil winding 27 is energized, an armature electromagnetic field is established. When energized, the coil winding 27 and armature electromagnetic field pull the pintle needle 17 up away from the valve seat 21. An electrical connector 29 connects the pintle valve 13 to an electronic source. A filter gasket 31 is provided to filter the mixture to prevent debris from clogging the pintle needle 17 and valve seat 21.

Various potential pintle-valve control schemes have been identified. These include: pintle commutation—altering the amount of open or closed pintle valves to alter flow; pulse width modulation—delivering rapid on-off signals resulting in an effective average that lies between zero and one-hundred percent (0-100%) of the flow capability; orifice size —selecting pintle valves of various orifice sizes or flow rates and selectively choosing which pintle valves to combine; and inlet pressure—by raising and lowering the pressure on the pintle-valve inlet the flow can be further controlled.

Examples of various automotive pintle valves for use in the example computer-controlled valve array 11 of FIG. 1 can include a compact pintle valve, a standard pintle valve, and a long pintle valve. By selecting pintle valves with different fluid-flow profiles, it is possible to have multiple flow rate combinations. By combining multiple pintle valves with various flow rates, and controlling how the pintle valves cycle on and off, it is possible to deliver a precise volume and flow rate of fluid. Although typically used to regulate the flow of fuel, automotive pintle valves are also capable of regulating the flow of high-pressure gas. Pintle valve cycling can create abrupt pressure changes that must also be mitigated in a computer-controlled valve array application as described below.

The pintle valves 13 are provided between an intake manifold 46 and an outtake manifold 48. Thus, the intake manifold 46 and the outtake manifold 48 comprise a computer-controlled-valve-array (CCVA) 11 that fixtures an array of pintle valves 13 so that fluids travel in on one side of the pintles valves 13, through the intake manifold 46, and thus leaves out of the pintle valves 13 and into the outtake manifold 48. The intake manifold 46 initially maintains the two fluids in separate chambers connected to multiple pintle-valve inlets. Once triggered by the target-device or the computer-controlled process, the pintle valves 13 can open to allow fluid through.

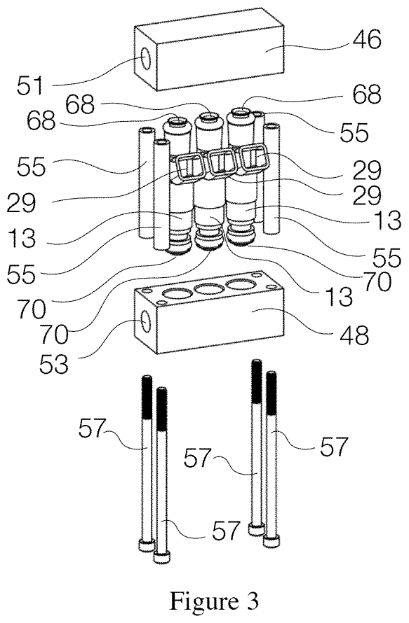

In more detail and referring to FIG. 3, an exploded view of the example computer-controlled valve array 11 of FIG. 1 is seen. A fluid inlet 51 is in fluid communication with the inlet manifold 46. The pintle valves 13 are positioned with a plurality of spacers 55 and secured between the inlet manifold 46 and the outtake manifold 48. The outtake manifold 48 further includes fittings that can receive a passive pressure snubber, a gas sensor, and a pressure sensor port. The outtake manifold 48 further includes an outlet 53. Working with the pintle-valve spacers 55, a plurality of bolts 57 secure the assembly together.

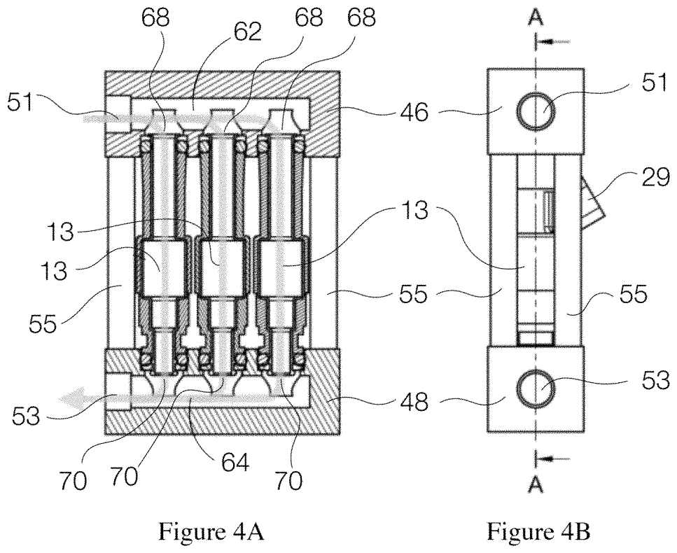

More detail with respect to the intake and outtake manifolds are provided with respect to FIGS. 4A-4B: FIG. 4B is an elevated view of the example computer-controlled valve array 11 of FIG. 1 and FIG. 4A is a front, sectional view of the example computer-controlled valve array 11 of FIG. 1 taken along the line indicated by “A” in FIG. 4B. The intake manifold 46 defines an intake chamber 62 in fluid communication with the inlets 68 of the pintle valves 13; likewise, the outtake manifold 48 defines an outtake chamber 64 in fluid communication with the outlets 70 of the pintle valves 13.

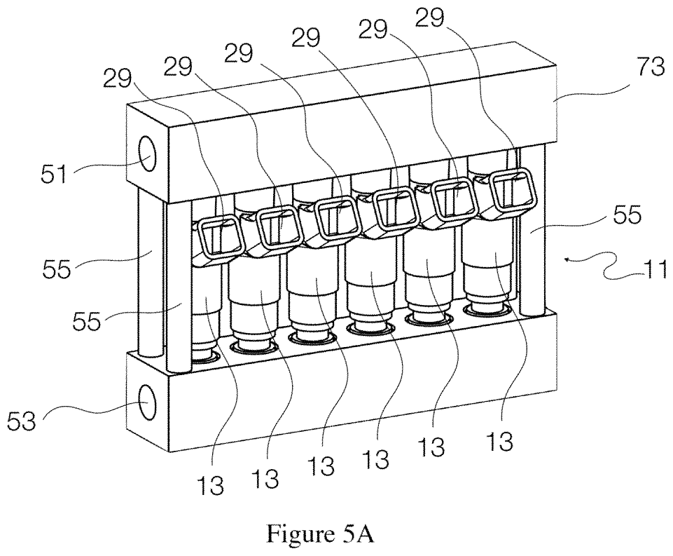

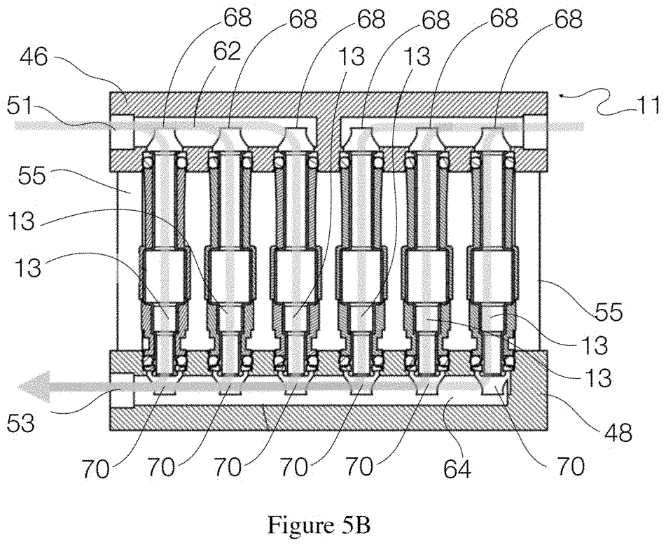

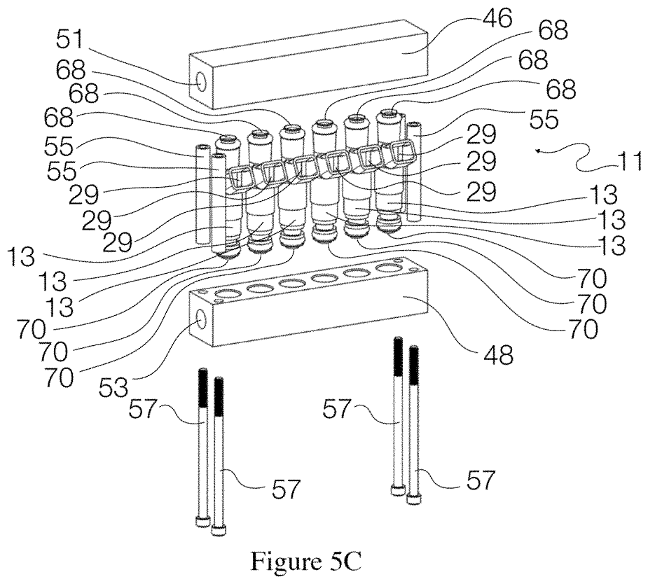

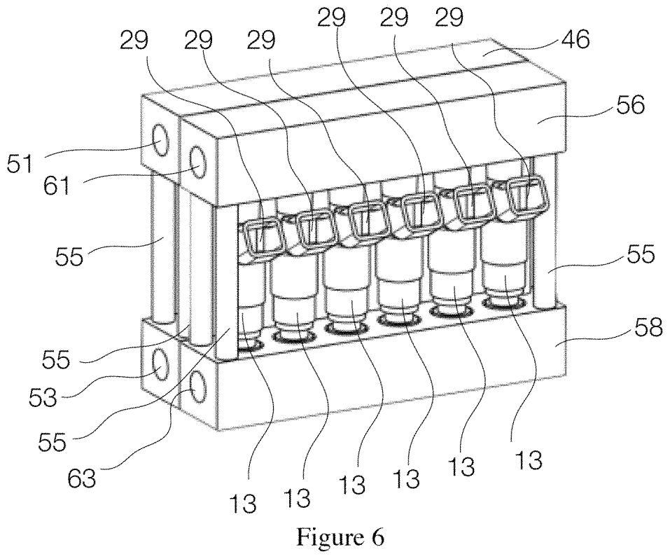

Depending on the desired application, the basic three valve, three flow, one array computer-controlled valve array 11 of FIG. 1 can be utilized as a building block in various configurations to achieve various pressure, flow, and volume combinations. Various additional examples of combinations can include use of one or more basic three valve, three flow, one array computer-controlled valve arrays in series, in parallel, and opposed. FIGS. 5 and 6 show computer-controlled valve array assemblies according to additional example embodiments in accordance with the principals of the present invention, The FIG. 5 example shows two basic three valve, three flow, two array computer-controlled valve arrays in parallel. The FIG. 6 example shows two computer-controlled valve array assemblies of FIG. 5 in parallel having four ports, six valves, three flows, and two arrays.

Referring to FIGS. 5A-5C, FIG. 5A is a perspective view of the basic three valve, three flow, two array computer-controlled valve arrays in parallel, FIG. 5B is a front, sectional view of the example computer-controlled valve array of FIG. 5A while FIG. 5C is an exploded view of the example computer-controlled valve array of FIG. 5A. This embodiment of the computer-controlled valve array 11 includes an inlet manifold 46 that defines an internal first-fluid inlet chamber 62 for one fluid and an internal second-fluid inlet chamber 75 for a second fluid. The first-fluid inlet chamber 62 is in fluid communication with the source of high pressure first fluid via a first fluid intake port 51; the second-fluid inlet chamber 75 is in fluid communication with the source of high pressure second fluid via a second fluid intake port 73. A first plurality of pintle-valve 13 inlets is in fluid communication with the first-fluid inlet chamber 62; a second plurality of pintle-valve 13 inlets are in fluid communication with the second-fluid inlet chamber 75.

The outtake manifold 48 defines an internal outtake chamber 64. Outlets of the first and second pluralities of pintle valves 13 are in fluid communication with the outtake chamber 64; thus, the first and second fluid mix in the outtake chamber 64. The outtake chamber 64 is in fluid communication with an outtake port 53. This outtake port 53 can be fitted with a passive pressure snubber or a port to a flexible chamber to reduce pressure spikes as required by the application.

Referring to FIG. 6, this example shows two computer-controlled valve array assemblies of FIG. 5 in parallel having four ports, six valves, three flows, and two arrays. Thus, the FIG. 6 example includes two inlet manifolds 46, 56; two first fluid inlet ports 51, 61; two outlet manifolds 48, 58; two fluid outlet ports 53, 63.

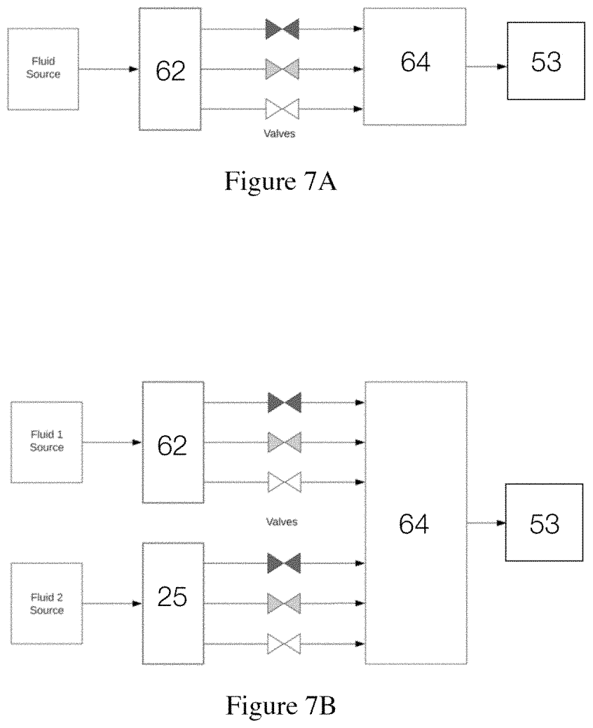

Referring to FIG. 7A, a fluid-flow chart of the example computer-controlled valve array of FIG. 1 is seen. The high-pressure fluid source provides fluid to the fluid intake chamber of the intake manifold. The fluid-intake chamber of the intake manifold is in fluid communication with the inlets of a plurality of pintle valves. The outlets of the pintle valves are in fluid communication with the receiving chamber of the outtake manifold. The outtake chamber of the outtake manifold thus provides the fluid delivery to the outlet port.

Referring to FIG. 7B, a fluid-flow chart of the example computer-controlled valve array of FIG. 5A-5C is seen. The first high-pressure fluid source provides fluid to the first intake chamber of the intake manifold; likewise, the second high-pressure fluid source provides fluid to the second intake chamber of the intake manifold. The first fluid intake chamber of the intake manifold is in fluid communication with the inlets of the first plurality of pintle valves; likewise, the second fluid intake chamber of the intake manifold is in fluid communication with the inlets of the second plurality of pintle valves. The outlets of the first and second plurality of pintle valves are in fluid communication with the receiving chamber of the outtake manifold, where the two fluids mix. The receiving chamber of the outtake manifold thus provides the fluid mix to the outlet port.

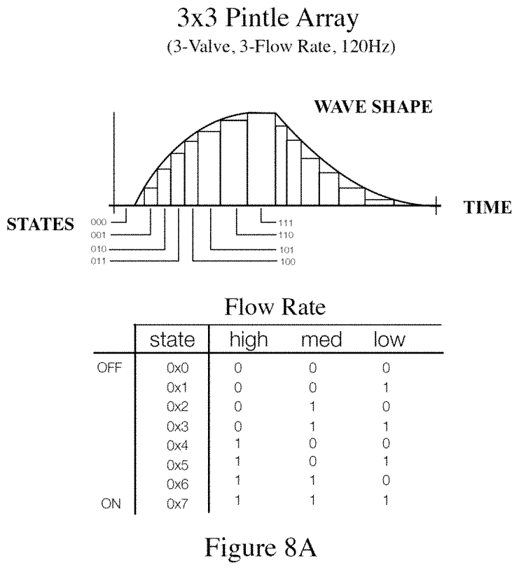

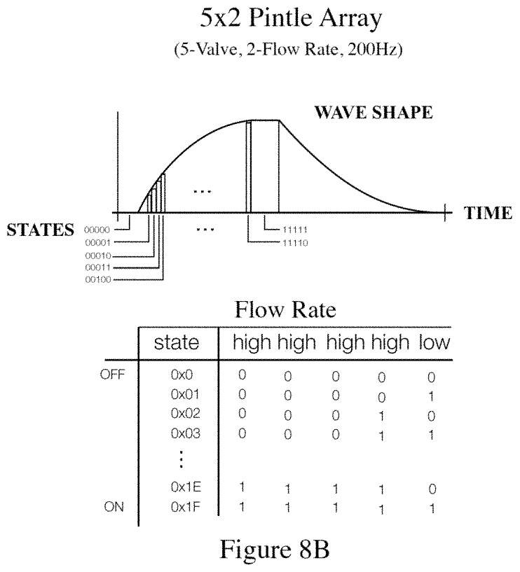

By varying the number of open pintle valves from each chamber, the individual flow rates of the pintle valves, and how long the pintle valves are open, it is possible to vary the flow rate, volume, gas fraction, and pressure delivered. Referring to FIGS. 8A and 8B, two example wave-shape graphs are seen showing how the pintle valves can be turned on to create a desired wave shape. In FIG. 8A, a three-by-three (3×3) pintle-valve array is depicted, having three pintle valves, three flow rates, and 120 Hz. The top portion of FIG. 8A graphs the waveform while the bottom portion is a table showing the flow rate. In FIG. 8B, a five-by-two (5×2) pintle-valve array is depicted, having five pintle valves, two flow rates, and 200 Hz. Again, the top portion of FIG. 8B graphs the waveform while the bottom portion is a table showing the flow rate.

The array of pintle valves in the computer-controlled valve array is modulated by a computer-controlled, wave-shaping process that determines possible pintle-valve states (on/off) in a lookup table in real-time. An arbitrary number of pintle valves, an arbitrary flow rate for each pintle valve (that is, low, medium, high), and a timing interval sufficiently determine the states.

Such wave shapes could be, but are not limited to a sine, triangle, square wave or any arbitrary waveform. In accordance with the principals of the present invention, the computer-controlled wave-shape process used herein has two primary variations that represent pressure and flow rate of a computer-controlled valve array to a target-device.

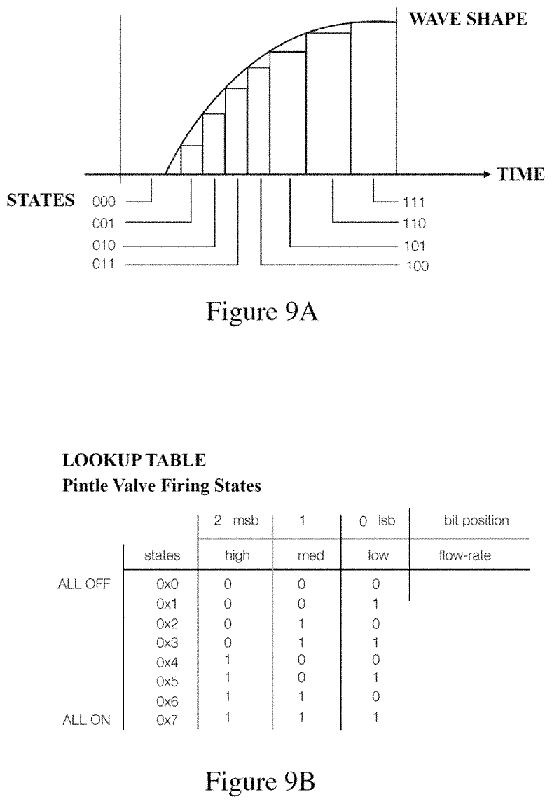

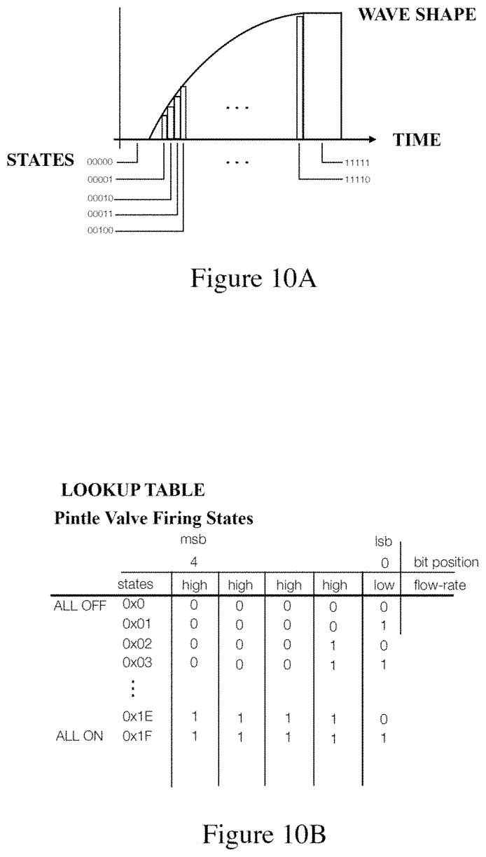

Referring to FIG. 9, a waveform graph is seen in FIG. 9A while a pintle-valve state lookup table is seen in FIG. 9B. In this example, the three-by-three (3×3) pintle-valve array configuration of FIG. 8A is utilized, having three pintle valves, three flow rates, and 120 Hz.

An incoming analog signal can serve as a control signal that determines the desired pressure, volume, and wave shape over time. The amplitude of the incoming signal can trigger thresholds that correspond to logic states in a lookup table that define the states pattern of the pintle-valve array.

While an apparatus in accordance with the principals of the present invention has been described with specific embodiments, other alternatives, modifications, and variations will be apparent to those skilled in the art. Accordingly, it will be intended to include all such alternatives, modifications and variations set forth within the spirit and scope of the appended claims.

What is claimed is:

1. A computer-controlled valve array to meter fluids comprising:
an intake manifold defining a fluid-inlet chamber;
a fluid inlet in fluid communication with the fluid-inlet chamber of the intake manifold, the fluid inlet adapted to receive a high-pressure source of fluid;
a plurality of valves having an inlet and an outlet, at least one valve inlet in fluid communication with the fluid-inlet chamber, the valves being electronically controlled to allow fluid through in response to a trigger;
an outtake manifold in fluid communication with the valve outlets, and
outlet ports in fluid communication with the outtake chamber of the outlet manifold, the outlet ports adapted to receive and fluid communicate with the output circuit.

2. The computer-controlled valve array to meter fluids of claim 1 further comprising a three valve, three flow, one array computer-controlled valve array.

3. The computer-controlled valve array to meter fluids of claim 1 further wherein the valves comprise small electronic solenoids biased shut by small, spring-loaded needle.

4. The computer-controlled valve array to meter fluids of claim 3 further wherein the valves comprise pintle valves.

5. The computer-controlled valve array to meter fluids of claim 3 further wherein the pintle valves are selected from a group consisting of a compact pintle valve, a standard pintle valve, a long pintle valve, and combinations thereof.

6. The computer-controlled valve array to meter fluids of claim 4 further comprising coil windings which, when energized, create an armature electromagnetic field that pulls the pintle needle up away from a valve seat.

7. The computer-controlled valve array to meter fluids of claim 1 further comprising control schemes selected from the group consisting of pintle commutation; pulse width modulation; orifice size; inlet pressure; and combinations thereof.

8. The computer-controlled valve array to meter fluids of claim 1 further wherein the manifold further comprises fittings to receive a passive pressure snubber.

9. The computer-controlled valve array to meter fluids of claim 1 further wherein the manifold further comprises fittings to receive a gas sensor.

10. The computer-controlled valve array to meter fluids of claim 1 further wherein the manifold further comprises fittings to receive a pressure sensor port.

11. The computer-controlled valve array to meter fluids of claim 1 further comprising an inlet manifold that defines a first internal inlet chamber for one fluid and a second internal inlet chamber for a second fluid.

12. The computer-controlled valve array to meter fluids of claim 11 further wherein the first internal inlet chamber is in fluid communication with a source of high pressure first fluid and the second-fluid inlet chamber is in fluid communication with a source of high pressure second fluid.

13. The computer-controlled valve array to meter fluids of claim 1 further wherein the outtake manifold defines an internal receiving chamber wherein the first and second fluid mix.

14. The computer-controlled valve array to meter fluids of claim 1 further comprising varying the number of open valves from each chamber, the individual flow rates of the valves, and how long the valves are open to vary the flow rate, volume, gas fraction, and pressure delivered.

15. The computer-controlled valve array to meter fluids of claim 1 further comprising modulating the computer-controlled valve array by a computer-controlled, wave-shaping process that determines possible valve states (on/off) in a lookup table in real-time.

16. The computer-controlled valve array to meter fluids of claim 15 further wherein the wave-shapes are selected from a group consisting of sine, triangle, square wave, and combinations thereof.
